(19) United States
(12) Patent Application Publication
(10) Pub. No.: US 2019/0170963 A1
(43) Pub. Date: Jun. 6, 2019

(54) METHOD FOR MAKING CARBON FIBER OPTOMECHANICAL DEVICES

(71) Applicant: Meopta - optika, s.r.o., Prerov (CZ)

(72) Inventor: JIRI VLK, Prerov (CZ)

(21) Appl. No.: 16/204,652

(22) Filed: Nov. 29, 2018

Related U.S. Application Data
(60) Provisional application No. 62/593,510, filed on Dec. 1, 2017.

(51) Int. Cl. G02B 7/00

(52) U.S. Cl. CPC G02B 7/008

(57) ABSTRACT

A method for using carbon fiber in optomechanical devices to ensure critical parameter control by winding carbon fibers on a precisely fabricated spine to construct a composite base comprising a carbon fiber tube attached to construction nodes made of conventional material for holding detachable conventional optical components is disclosed.

### CROSS-REFERENCE TO RELATED APPLICATION

The present application claims the benefit of previously filed co-pending Provisional Patent Application, Ser. No. 62/593,510, filed on Dec. 1, 2017.

### FIELD OF THE INVENTION

The method of this disclosure belongs to the field of optomechanical devices. More specifically it is a new method for using carbon fiber in the making of optomechanical devices such as a carbon fiber coupler.

### BACKGROUND OF THE INVENTION

Composite materials have become more and more commonly used in many different technical fields. These materials offer countless possibilities for applying brand new approaches to design solutions and also bring a significant increase of utility properties to the final products. Using composite materials in optomechanical assemblies will add these same possibilities to these devices.

The tuneability of the material properties of composite parts suggests that this material should be used not only in the scope-optics business but also in various optomechanical assemblies with optical specifications that are set close to the physical limits. What is particularly beneficial is the predefineable behavior of the specific composite structure for various types of optomechanical products.

Parameters such as minimal thermal expansion, stiffness or elasticity, shock resistivity, or, for example, very low weight, play a key role in optomechanical design and the optimization of these parameters can mean a decided added value compared to the conventional solutions in the prior art. The use of carbon fiber composite materials helps to tune all those parameters to an in-advance-specified level.

This disclosure describes a method for making a hybrid carbon fiber composite structure proper for implementation into optomechanical assemblies.

### BRIEF SUMMARY OF THE INVENTION

What is disclosed is a new method for using carbon fiber in the making of optomechanical devices such as a carbon fiber coupler.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a perspective view of the carbon fiber coupler without optical components of the preferred embodiment; and,

FIG. 2 shows a cross sectional diagram of the carbon fiber coupler with optical components of the preferred embodiment.

### DESCRIPTION OF THE PREFERRED EMBODIMENT

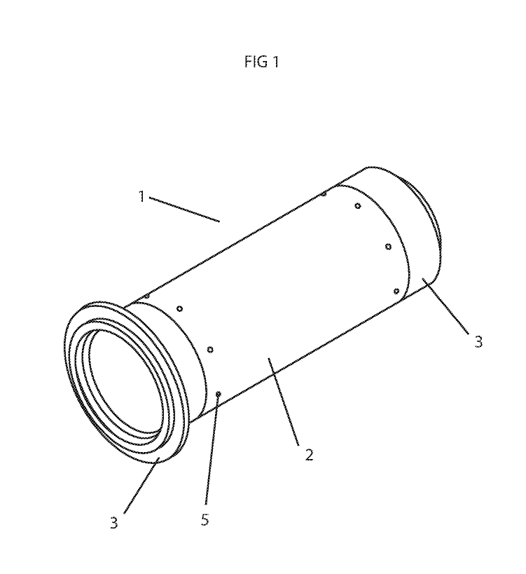

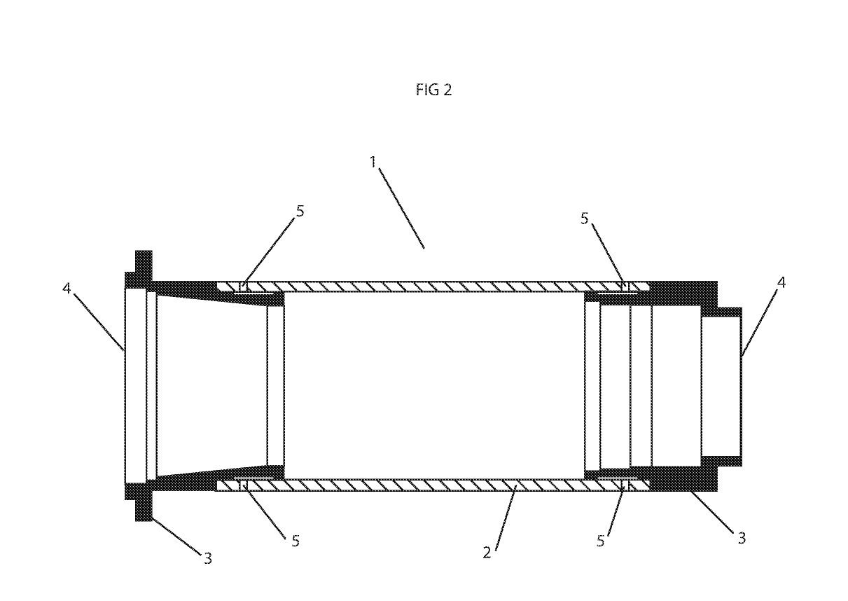

This disclosure describes the device and method to provide a hybrid composite structure proper for implementation into optomechanical assemblies such as the fiber optic coupler (1) preferred embodiment shown in FIGS. 1 and 2. The resulting fiber optic coupler (1) is created using the technology of winding carbon fibers on a precisely fabricated spine to construct the carbon tube (2). Other methods may also be used such as spinning, molding or extruding as is well known by those skilled in the art.

Obtaining particular specified structural properties is the result of making the right choice of fiber type and material as is known by those skilled in the art of carbon fibers. The final constructed device (such as the carbon fiber coupler (1) preferred embodiment) is a hybrid composite structure. More specifically it is a novel composition of the carbon fiber tube (2) and several construction nodes (3) fabricated out of stainless steel or other suitable materials such as aluminum, ceramic, titanium or plastic as is well known in the art, attached at the attachment points (5) by gluing or other similar means to the carbon fiber tube (2) in a conventional way along with attached conventional optical components (4). All conventional optical components (4) of the final hybrid structure (such as the carbon fiber coupler (1) preferred embodiment) are firmly fixed to the composite base (2 and 3) in such a way that they are disconnectable or disinstallable from the carbon fiber structure of the composite base (2 and 3).

Once the composite base (2 and 3) is assembled the stainless steel construction nodes (3) are final machined for parallel, perpendicular, and or concentric alignment. The conventional optical components and/or subassemblies (4) are then assembled into the stainless steel construction nodes (3). Due to the low expansion rate of the carbon fiber, it will stay aligned during temperature changes and cycles. The carbon fiber is lighter, less expensive to produce, and better performing than if the entire assembly were made out of stainless steel as done in the prior art and can easily be made into other shapes such as tapered or conical as is well known in the art. Multiple tubes can also be connected and disconnected to create variable length and shaped hybrid composite structures.

Finally, the disclosed approach broadens the possibilities for installation of optical elements into an assortment of optomechanical products by considering and utilizing all relevant properties of the disclosed method of making the hybrid composite structure.

Since certain changes may be made in the above described method of using carbon fiber in optomechanical devices to ensure critical parameter control without departing from the scope of the invention herein involved, it is intended that all matter contained in the description thereof, or shown in the accompanying figures, shall be interpreted as illustrative and not in a limiting sense.

What is claimed is:

1. A method for using carbon fiber in the making of optomechanical hybrid composite devices such as a carbon fiber coupler comprising:
preparing a carbon fiber tube;
attaching two or more construction nodes fabricated out of stainless steel at attachment points to said carbon fiber tube forming a hybrid composite base;
machining said stainless steel construction nodes for parallelism; and,
assembling conventional optical components into said stainless steel construction nodes.

2. The method of claim 1 wherein said carbon fiber tube is prepared by winding or spinning carbon fibers on a spine.

3. The method of claim 2 further comprising including the encapsulation of metal or optical elements during the winding or spinning process.

4. The method of claim 1 wherein said carbon fiber tube is prepared by molding or extruding.

5. The method of claim 1 wherein said machining to parallelism further includes machining to perpendicular and concentric.

6. The method of claim 1 wherein said stainless steel is replaced by some other material such as aluminum, ceramic, titanium, or plastic.

7. The method of claim 1 wherein said attaching is accomplished by gluing, press fitting, screwing, or welding.

8. The method of claim 1 wherein said carbon fiber tube is tapered, conical, or other shape to accommodate different size optical components.

9. The method of claim 8 wherein said carbon fiber tube can be connected and disconnected to another said carbon fiber tube creating variable length and shaped hybrid composite structures.
